(19) United States
(12) Patent Application Publication
(10) Pub. No.: US 2024/0127026 A1
(43) Pub. Date: Apr. 18, 2024

(54) SHALLOW-DEEP MACHINE LEARNING CLASSIFIER AND METHOD

(71) Applicant: iNTUIT INC., Mountain View, CA (US)

(72) Inventors: Esmeralde Manandise, Tallahassee, FL (US); Anu Singh, Mountain View, CA (US); Raj Srivastava, Mountain View, CA (US)

(73) Assignee: INTUIT INC., Mountain View, CA (US)

(21) Appl. No.: 18/488,993

(22) Filed: Oct. 17, 2023

Related U.S. Application Data
(60) Provisional application No. 63/417,235, filed on Oct. 18, 2022.

(51) Int. Cl. G06N 3/006; G06F 16/33; G06N 3/08

(52) U.S. Cl. CPC G06N 3/006; G06F 16/3344; G06F 16/3347; G06N 3/08

(57) ABSTRACT

A method including receiving a natural language query from a user interface of a chatbot. The method also includes generating an input vector by performing vectorization on the natural language query. The method also includes inputting the input vector to a shallow-deep classifier. The shallow-deep learning classifier includes a classification machine learning model programmed to classify the input vector as being one of a shallow machine learning classification problem and a deep machine learning classification problem. The method also includes outputting, by the shallow-deep classifier, an output label. The output label includes one of the shallow machine learning classification problem and the deep machine learning classification problem.

### CROSS REFERENCE TO RELATED APPLICATIONS

This application claims the benefit of U.S. Provisional Application 63/417,235, filed Oct. 18, 2022, which is incorporated by reference herein.

### BACKGROUND

Chatbots use machine learning models to parse natural language queries and then to generate answers to the queries. For example, a chatbot might prompt “how can I help you today?” The user may enter a reply such as “what is a vegetable?” The chatbot would then use a natural language machine learning model to create a machine-interpreted understanding of the question. Based on a machine-interpreted understanding of the phrase, the chatbot is programmed to return information on a definition of the word “vegetable.”

### SUMMARY

One or more embodiments provide for a method. The method includes receiving a natural language query from a user interface of a chatbot. The method also includes generating an input vector by performing vectorization on the natural language query. The method also includes inputting the input vector to a shallow-deep classifier. The shallow-deep learning classifier includes a classification machine learning model programmed to classify the input vector as being one of a shallow machine learning classification problem and a deep machine learning classification problem. The method also includes outputting, by the shallow-deep classifier, an output label. The output label includes one of the shallow machine learning classification problem and the deep machine learning classification problem.

One or more embodiments also provide for a system. The system includes a processor and a data repository in communication with the processor. The data repository stores a natural language query and an input vector. The data repository also stores an output label including one of a shallow machine learning classification problem and a deep machine learning classification problem. The system also includes a shallow-deep classifier executable by the processor. The shallow-deep classifier includes a classifier machine learning model programmed to determine whether the natural language query represents the shallow machine learning classification problem or the deep machine learning classification problem. The system also includes a server controller which, when executed by the processor, is programmed to perform a method. The server controller is programmed to receive the natural language query. The server controller is also programmed to generate the input vector by performing vectorization on the natural language query. The server controller is also programmed to generate the output label by executing the shallow-deep classifier on the input vector.

One or more embodiments also provide for another method. The method includes receiving a natural language query from a user interface of a chatbot. The method also includes generating an input vector by performing vectorization on the natural language query. The method also includes inputting the input vector to a shallow-deep classifier. The shallow-deep learning classifier includes a classification machine learning model programmed to classify the input vector as being one of a shallow machine learning classification problem and a deep machine learning classification problem. The method also includes outputting, by the shallow-deep classifier, an output label. The output label includes one of the shallow machine learning classification problem and the deep machine learning classification problem. The method also includes inputting, responsive to the output label including deep, the input vector to a deep classifier including deep natural language machine learning model. The method also includes outputting, by the deep classifier, an intent classification that represents an intent of the natural language query. The method also includes generating a weighted classification by applying a weight to the intent classification. The method also includes generating a comparison by comparing the weighted classification to a threshold. The method also includes transmitting either i) the input vector and the intent classification to a topic classifier including a topic classification machine learning model when the comparison satisfies the threshold, or, ii) the input vector to the topic classifier when the output label includes the shallow machine learning classification problem. The method also includes classifying, by the topic classifier executing on the input vector, a topic of the natural language query. The method also includes selecting, from among a plurality of chatbots and based on the topic, a selected chatbot. The method also includes generating, automatically by the selected chatbot, a chatbot response to the natural language query. The selected chatbot also uses the intent classification to generate the chatbot response when the intent classification is present. The method also includes transmitting the chatbot response to a user device.

### BRIEF DESCRIPTION OF DRAWINGS

FIG. 1A, FIG. 1B, and FIG. 1C show a computing system, in accordance with one or more embodiments.

FIG. 2 shows a method, in accordance with one or more embodiments.

FIG. 3 shows an example natural language machine learning system for use with a chatbot, in accordance with one or more embodiments.

FIG. 4 shows a chart illustrating an average fallback rate for the system shown in FIG. 3, in accordance with one or more embodiments.

FIG. 5 shows “table 1”, which is a table of sample of real-time raw and simplified queries, in accordance with one or more embodiments.

FIG. 6 shows “table 2”, which is a table of utterance candidates for shallow versus deep parsing, in accordance with one or more embodiments.

FIG. 7 shows a graph of mutual information scores, in accordance with one or more embodiments.

FIG. 8 shows a graph of random forest feature weights, in accordance with one or more embodiments.

FIG. 9 shows a graph comparing performance of different classifiers used with respect to the system shown in FIG. 3, in accordance with one or more embodiments.

FIG. 10 shows a graph of the measured recall of a random forest classifier on gold standards with varied training set sizes, in accordance with one or more embodiments.

FIG. 11 shows “table 3”, which is a table of data distribution of 50,000 training samples, in accordance with one or more embodiments.

FIG. 12 shows a graph of a percentage of true Boolean features, in accordance with one or more embodiments.

FIG. 13 shows a graph of the mean value of numerical features, in accordance with one or more embodiments.

FIG. 14A and FIG. 14B show a computing system and network environment, in accordance with one or more embodiments.

Like elements in the various figures are denoted by like reference numerals for consistency.

### DETAILED DESCRIPTION

In general, the one or more embodiments are directed to improved machine learning classifiers. More particularly, the one or more embodiments are directed to an improved system of machine learning classifiers that may be used to improve the performance of a chatbot.

A technical problem can arise in chatbots. In particular, a machine learning classifier may misidentify the intent of a user. For example, a user may type “Thanks for not answering my question.” A human reader would understand that the user intends to convey a meaning that the chatbot failed to address the user's issue, and to convey the meaning with a sarcastic, derogatory remark that indicates that the user is displeased and frustrated with the product being used. However, some natural language classifiers would heavily weight the word “thanks,” and thereby misidentify the user's phrase as conveying gratitude for the service rendered. Thus, the chatbot may respond with the phrase, “You are welcome, I am glad I helped you!” However, the user may become more frustrated or upset, as the user will appreciate that the chatbot did not understand the user's intent. The frustrated user may take an undesirable action, such as to cease using the product.

The one or more embodiments address this and other technical problems in using machine learning models to classify user intent. Improved classification of user intent, in turn, leads to more accurate or more appropriate responses from chatbots. Thus, continuing the above example, in response to the derogatory user remark the chatbot would instead reply with “I am sorry I could not help you, I will find someone who can.” The chatbot would then transfer the user to a live customer service agent (i.e., a trained person). As a result, the user may be satisfied that progress was being made to resolve the user's issue.

In particular, the one or more embodiments include a shallow-deep machine learning classifier, referred-to as a “SD classifier.” The SD classifier may be used to parse natural language statements received by a chatbot. Specifically, the SD classifier determines whether the statement should be classified using a “shallow” classifier, or using a “deep” classifier.

Deep classifiers use more processor and bandwidth resources, and thus may be slower to respond than shallow classifiers. However, deep classifiers are more accurate. However, maintaining the heavier computing resources used by deep classifiers may not be desirable for those queries that produce desirably accurate results using shallow classifiers.

For this reason, it is desirable to use deep classifiers for classifying phrases that have true meanings that are more difficult for a computer to parse, but to use shallow classifiers for classifying phrases that have true meanings that are easier for a computer to parse. However, a machine learning model cannot evaluate the difficulty of interpreting any given input phrase. Rather, a machine learning model simply produces an output based on the programming and training of the machine learning model, leading possibly to the undesirable results described above. Thus, if accuracy is desired above efficiency, an organization may elect to use an undesirable amount of computing resources, and hence money and other resources, to process all incoming messages using a deep classifier. This result may also be undesirable or deemed sub-optimal.

One or more embodiments address the above-described technical problems. In particular, the SD classifier of one or more embodiments is capable of identifying which input phrases should be processed by a more cost-intensive deep classifier, and which input phrases may be processed by a less cost-intensive shallow classifier, while at least maintaining the accuracy of deep classifiers when performing computerized phrase interpretation. In other words, one or more embodiments may maximize the speed of response of the chatbot, while minimizing the computing cost of operating the chatbot, and further while returning replies to a user that are as accurate, or nearly as accurate, as using a deep classifier to process all input phrases.

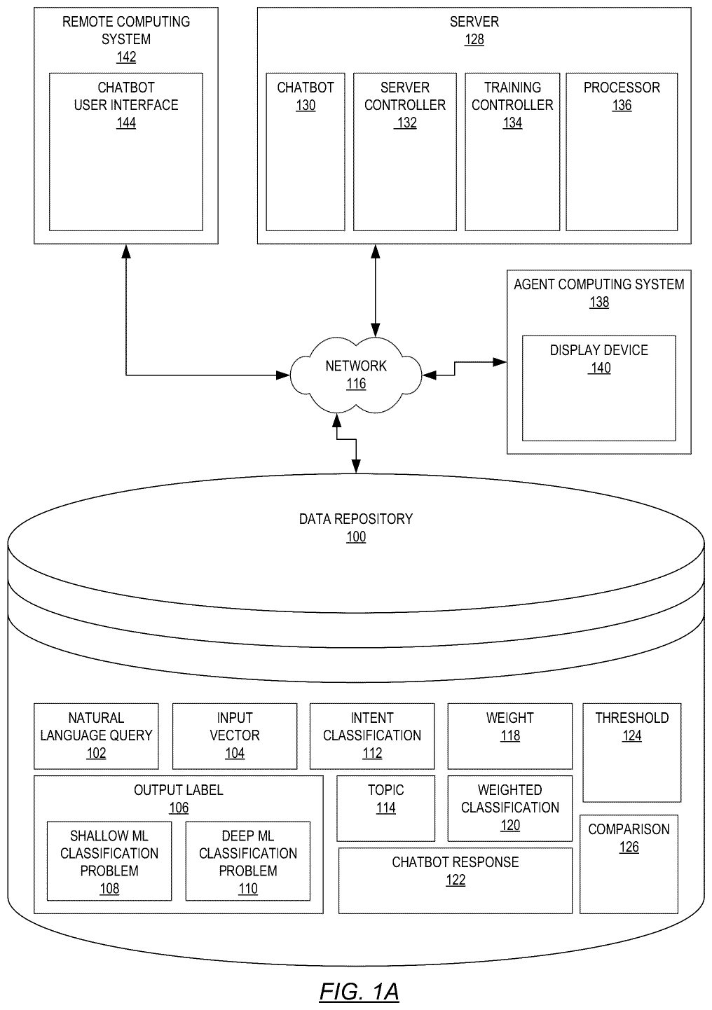

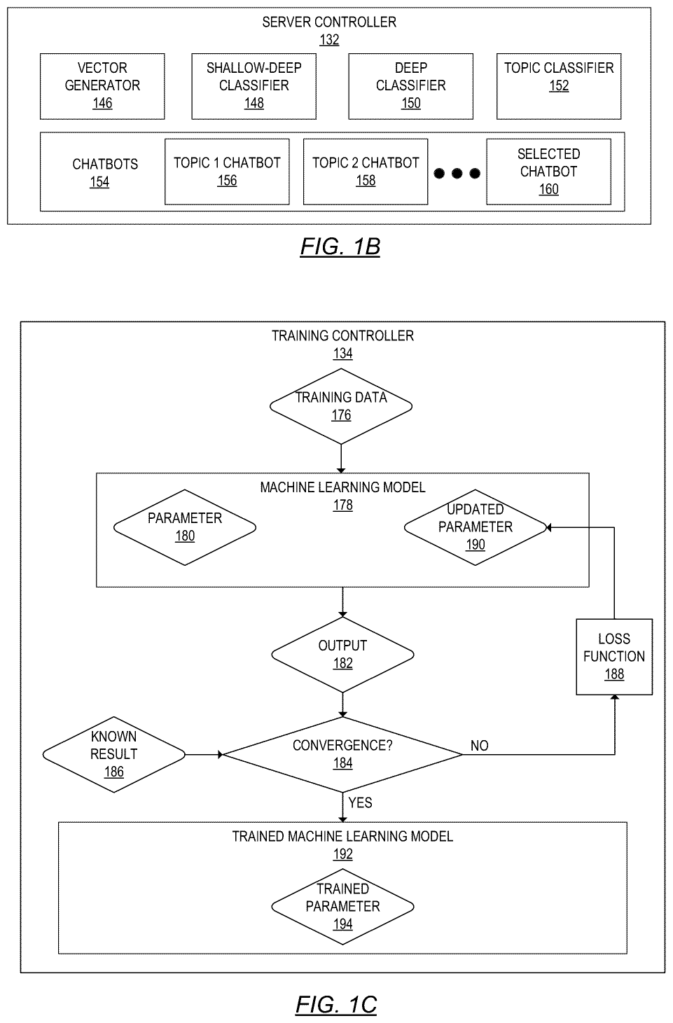

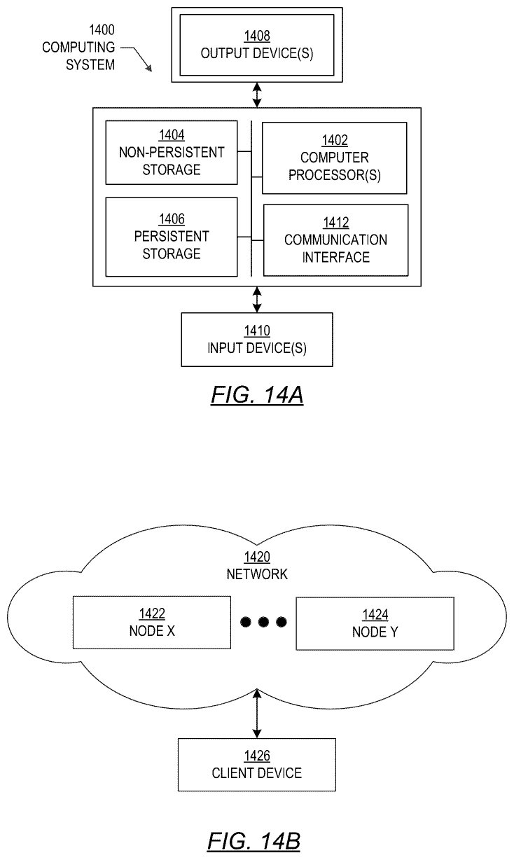

FIG. 1A shows a computing system, in accordance one or more embodiments. The computing system shown in FIG. 1A may be implemented using one or more processors and data repositories, possibly in a distributed computing environment, such as for example shown in FIG. 14A and FIG. 14B.

The computing system also includes a data repository (100). The data repository (100) is a type of storage unit and/or device (e.g., a file system, database, data structure, or any other storage mechanism) for storing data. The data repository (100) may include multiple different, potentially heterogeneous, storage units or devices. The data repository (100) also may store information useable by one or more of the remote computing system (142), the server (128), and the agent computing system (138), described in detail below. The data repository (100) may be a non-transitory computer readable storage medium.

The data repository (100) may store a natural language query (102). The natural language query is a word or phrase expressed in a human-readable language. The natural language query (102) may be received from the chatbot user interface (144) of the remote computing system (142) (see below).

The data repository (100) also may store an input vector (104). The input vector (104) is a data structure, such as but not limited to a 1×N matrix data structure for storing computer readable data. The input vector (104) is suitable for input to a machine learning model. The input vector (104) includes features and values. A feature is type of information of interest (e.g., a word, a phrase, a letter, a number, etc.). The value is a value for the feature. For example, if the feature is the word “cat,” and the word “cat” appears five times in the corpus, then the value of the feature may be “5.” Many different examples of features and vectors exist, and features are not limited to natural language text. The input vector (104) may be generated by a process known as vectorization, described with respect to FIG. 1B.

The data repository may store an intent classification (112). The intent classification (112) is the output of an intent classification machine learning model, such as the deep classifier (150) described with respect to FIG. 1B. The intent classification may be selected from a pre-determined set of intents, such as “gratitude,” “frustration,” “seeks clarification,” etc. Thus, the intent classification is a machine-readable expression of a machine-predicted intent of the user entering the natural language query (102) into the chatbot user interface (144).

The data repository (100) also may store an output label (106). The output label (106) is the output of the shallow-deep classifier (148) described with respect to FIG. 1B. The output label (106) may take the form of a number, text, or other value or values that represent whether the natural language query (102) represents a shallow ML classification problem (108) or a deep ML classification problem (110).

When the output label (106) is the shallow ML classification problem (108), then the shallow-deep classifier (148 of FIG. 1B) has classified the natural language query (102) as being one amenable to processing by a deep classifier, such as a random forest model, neural network, etc. Similarly, when the output label (106) is the deep ML classification problem (110), then the shallow-deep classifier (148 of FIG. 1B) has classified the natural language query (102) as being one amenable to processing by a shallow machine learning model typically used by chatbots, such as a logistic regression model. Note that the output label (106), in either case, may be the actual output of the shallow-deep classifier (148 of FIG. 1B). Alternatively, the output label (106) may be a numerical value, which is then treated as representing either the shallow ML classification problem (108) or the deep ML classification problem (110).

For example, the shallow ML classification problem (108) may result when the output value of the shallow-deep classifier (148 of FIG. 1B) fails to satisfy a pre-determined threshold value (e.g., 0.5 and below). The meaning of the output value failing to satisfy the pre-determined threshold value is that the natural language query is predicted to be taken at face-value. In other words, a shallow classification means that the natural language query (102) may be further processed by additional natural language machine learning processing for an automated response to the natural language query (i.e., for processing by a chatbot).

However, the deep ML classification problem (110) may result when the output value of the machine learning classifier satisfies the pre-determined threshold value (e.g. above 0.5). The meaning of the output value satisfying the pre-determined threshold value is that the natural language query (102) is predicted as being too difficult for an automated response shallow machine learning model to process to the natural language query (102) accurately. Thus, the natural language query (102) may be routed to a more computationally expensive deep classifier.

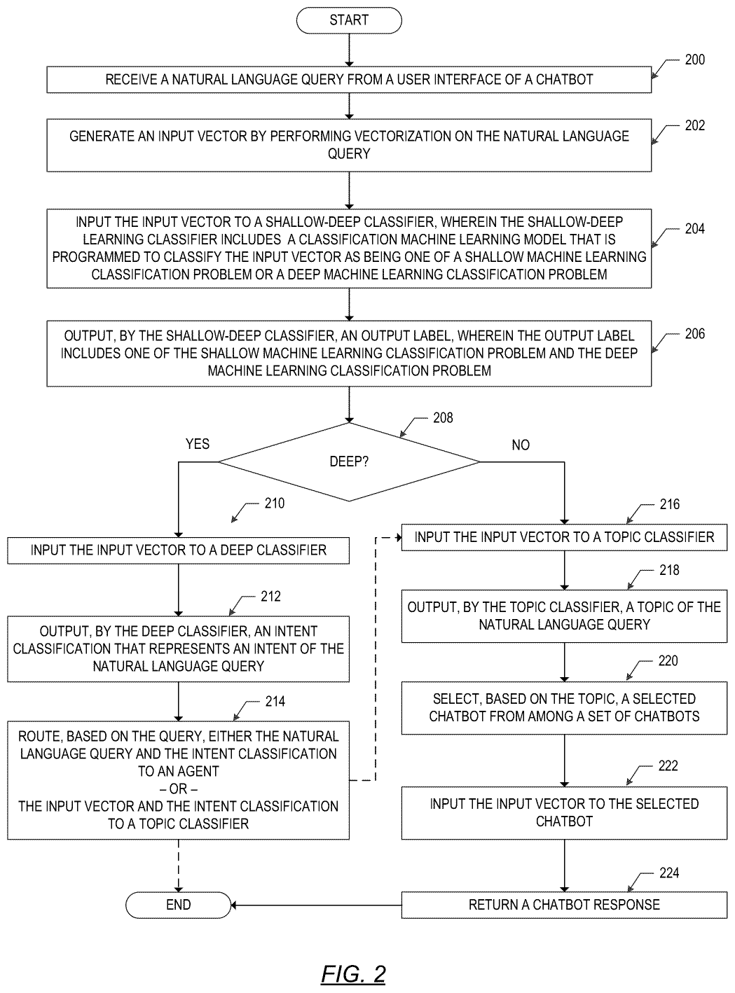

Treatment of the natural language query (102) after the classification label is assigned is described with respect to FIG. 2. Briefly, the shallow ML classification problem (108) label means that the natural language query (102) is interpreted and answered by a computationally inexpensive chatbot. However, the deep ML classification problem (110) label means that the natural language query (102) is handled in one of two other ways. The first way is to direct the natural language query (102) directly to the agent computing system (138), so that a human may respond. The second way is that the natural language query (102) is directed to a computationally more expensive deep classifier for a deeper semantic analysis of the natural language query (102).

The data repository (100) also may store an intent classification (112). The intent classification (112) is the output of the deep classifier (150), described with respect to FIG. 1B. Briefly, the deep classifier (150) is the deep classifier described above. The intent classification (112) may be any intent contained in the natural language query (102), as predicted by the deep classifier (150). Thus, the intent classification (112) is not necessarily the intent of the user that submitted the natural language query (102). However, again, the intent classification (112) is the intent of the natural language query (102), as predicted by the deep classifier (150). In many cases, if not the vast majority of cases, the intent classification (112) does represent the original intent of the user submitting the natural language query (102). Examples of the intent classification (112) may be “sarcastic,” “negative,” “positive,” “seeking clarification,” and many others.

The data repository (100) also may store a topic (114). The topic (114) is the output of a topic classifier (152), described with respect to FIG. 1B. The topic (114) is a selected topic selected from among a set of pre-determined topics. The topic (114) also represents the predicted topic of the natural language query (102). The topic may be used to determine which, among many, different chatbots may be selected for use in processing the natural language query (102). For example, if the topic (114) of the natural language query (102) is “tax deduction,” then the natural language query (102) may be routed to a chatbot that has been specifically trained on questions pertaining to tax deductions.

The data repository (100) also may store a weight (118). The weight (118) is a number that may be applied to the output of some other process. In particular, the weight (118) is applied to the intent classification (112) in order to generate a weighted classification (120). Thus, the weighted classification (120) is the intent classification (112) multiplied by the weight (118), which may change the result of the intent classification (112).

The data repository (100) also may store a chatbot response (122). The chatbot response (122) is the output of a chatbot, such as one of the chatbots (154) described with respect to FIG. 1B. For example, the chatbot response (122) may be human-readable text that may be transmitted to the chatbot user interface (144) of the remote computing system (142). In a specific example, the chatbot response (122) of the chatbot may be “here is the answer to your question,” along with a link or text that describes the predicted answer to the natural language query (102).

The data repository (100) also may store a threshold (124). The threshold (124) is a value against which an output of another process may be compared in order to make a subsequent determination. For example, a comparison may be made by comparing the weighted classification to a threshold, and then the intent classification may be routed based on the comparison, as described with respect to FIG. 2.

The data repository (100) also may store a comparison (126). The comparison (126) is the result of comparing the comparison operation described above with respect to the threshold (124). The comparison may be, for example, that the threshold (124) is satisfied or not satisfied. The precise definition of “satisfied’ may vary; however, in general, when threshold (124) is satisfied then some alternative action will be taken. Satisfaction of the threshold (124) may occur when the threshold (124) equals or exceeds the weighted classification (120), for example, and is conversely not satisfied when the threshold (124) fails to equal the weighted classification (120). However, in another example, the threshold (124) may be satisfied when the weighted classification (120) exceeds the threshold (124). Thus, the definition of satisfaction may vary.

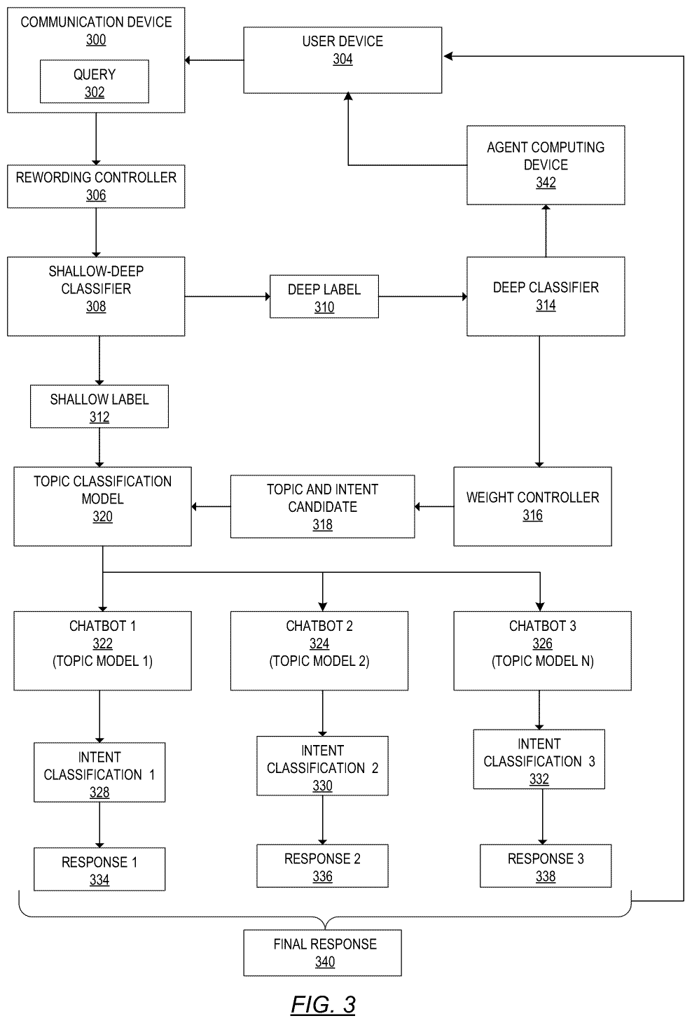

The computing system shown in FIG. 1 also includes a server (128). The server (128) is hardware, software, or a combination thereof that permits the server (128) to execute the operations of FIG. 2, or to execute the examples of FIG. 3 through FIG. 13. The server (128) may, for example, include one or more chatbots, such as the chatbot (130), a server controller (132), and training controller (134), and a processor (136), and possibly other components. The chatbot (130) may interact and transmit messages to and receive messages to the chatbot user interface (144) of the remote computing system (142). The messages may be natural language queries, such as the natural language query (102), or the chatbot response (122), or other human readable messages.

The chatbot (130) is a machine learning model. While the chatbot (130) may be a deep classifier, in an embodiment, the chatbot (130) is a shallow learning machine learning model. Examples of deep classifiers include neural networks, random forests, etc. Examples of shallow machine learning model include logistic regression machine learning models, supervised machine learning models, etc.

The server controller (132) executes one or more machine learning models or other programs using the processor (136). The server controller is described with respect to FIG. 1B.

The training controller (134) is software programmed to train a machine learning model, such as the machine learning classifiers described with respect to FIG. 1B. The training controller is described with respect to FIG. 1C.

The processor (136) is one or more hardware or virtual processors, possibly operating in a distributed computing environment. The processor (136) may be the computer processor(s) (1402 of FIG. 14A).

The computing system shown in FIG. 1A may also include an agent computing system (138). The agent computing system (138) is a computer operated by an agent responsible for helping users, such as the user operating the remote computing system (142) on which the chatbot user interface (144) executes. The agent computing system (138) includes a display device (140) for displaying information received from one or more of the remote computing system (142) system, the server (128), or the data repository (100).

Multiple agent computing systems may be present. In an embodiment, the agent computing system (138) is not part of the system of FIG. 1A, but rather is an external system operated by a third party other than the entity that maintains and operates the server (128) and the data repository (100).

The computing system of FIG. 1A communicates with a remote computing system (142) having a chatbot user interface (144). The remote computing system (142) is a user device used by a user that seeks to interact with the company, and thus may be interacting with the chatbot (130). The remote computing system (142) may generate the natural language query (102) via the chatbot user interface (144), and then transmit the natural language query (102) to the server (128) via the network (116). Thus, the chatbot user interface (144) is a display device which displays information to a user and which can receive input from the user via a user input device of the remote computing system (142).

The remote computing system may not be part of the computing system shown in FIG. 1A. For example, the remote computing system (142) may be a remote computer belonging to an user that is not part of the organization that owns and maintains the server (128) and the data repository (100), or the agent computing system (138). The remote computing system (142), however, could be owned by the organization that owns and maintains the server (128), the data repository (100), or the agent computing system (138).

The computing system shown in FIG. 1 may include a network (116). The network (116) may facilitate communication between the remote computing system (142), the server (128), the agent computing system (138), and the data repository (100). One or more aspects of the network (116) may not be part of the computing system shown in FIG. 1A, such as for example when the remote computing system (142) communicates with the server (128) via the Internet (i.e; at least the components of the Internet may or may not be part of the system shown in FIG. 1). However, some of the hardware and/or software that forms the network (116) may be part of the computing system shown in FIG. 1A.

FIG. 1B shows details of the server controller (132) also shown in FIG. 1A. The server controller (132) includes a vector generator (146). The vector generator (146) performs vectorization on the natural language query (102 of FIG. 1A.) Vectorization is a computer operation that transforms the natural language query (102) into a vector, such as the input vector (104). The vector, in turn, is machine readable format suitable for input to a machine learning model. The vector includes features and values, as described above for the input vector (104) in FIG. 1A.

The sever controller (132) also includes a shallow-deep classifier (148). The shallow-deep classifier (148) is a machine learning model programmed and trained to classify the natural language query (102 of FIG. 1A) as either being deep or shallow. Details of the operation of the shallow-deep classifier (148) are described with respect to FIG. 2. An example of the operation of the shallow-deep classifier (148) is described with respect to FIG. 3.

The server controller (132) also includes a deep classifier (150). The deep classifier (150) is a machine learning model programmed and trained to classify the intent classification (112) of the natural language query (102), as mentioned with respect to FIG. 1A. Details of the operation of the deep classifier (150) are described with respect to FIG. 2. An example of the operation of the deep classifier (150) is described with respect to FIG. 3.

The server controller (132) also includes a topic classifier (152). The topic classifier (152) is a machine learning model and/or heuristics which, when executed by a processor, generate the topic (114) of the natural language query (102), as described with respect to FIG. 1A. The topic classifier (152), when a machine learning model, is programmed and trained to identify the topic (114) of the natural language query (102 of FIG. 1A). Operation of the topic classifier (152) is described with respect to FIG. 2. An example of the operation of the topic classifier (152) is described with respect to FIG. 3.

The server controller (132) also includes one or more chatbots (154), such as the topic 1 chatbot (156), the topic 2 chatbot (158), and the selected chatbot (160). Each of the chatbots may be the chatbot (130), as defined with respect to FIG. 1A. Thus, each of the chatbots (154) may be a machine learning model. In an embodiment, each of the chatbots (154) is a shallow machine learning model that is programmed and trained to generate a human-readable response that appropriately responds to the natural language query (102 of FIG. 1A). The term “appropriately” means a computer-generated response that a human would believe answers the natural language query (102) in a way that the human would consider as being semantically related to the natural language query (102).

Each of the chatbots (154) may be trained according to a different topic. For example, the topic 1 chatbot (156) may be trained on training data (see FIG. 1C) that is related to a particular topic, such as the topic (114 of FIG. 1A). Similarly, the topic 2 chatbot (158) may be trained on training data that is related to a topic that is different than the training data upon which the topic 1 chatbot (156) is trained.

Once the topic (114) of the natural language query (102 of FIG. 1A) has been selected (see FIG. 2 or FIG. 3), then the natural language query (102) (including possibly the intent classification (112) of the natural language query (102) as determined by a deep classifier) may be routed to one of the chatbots (154) that corresponds to the topic (114) of the natural language query (102). Thus, the selected chatbot (160) is one of the chatbots (154) that is selected, based on the topic (114), to process the natural language query (102) (possibly together with the intent classification (112) of the natural language query (102)).

Attention is turned to FIG. 1C, which shows the details of the training controller (134). The training controller (134) is a training algorithm, implemented as software or application specific hardware, that may be used to train one or more the machine learning models described with respect to FIG. 1A and FIG. 1B.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model (i.e., the trained machine learning model (192)) is applied to the input vector (104 of FIG. 1A) in order to make predictions.

In more detail, training starts with training data (176). The training data (176) is data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178), as described before, is an algorithm. However, the output of the algorithm may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is a output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model being used (supervised versus unsupervised machine learning), or may be pre-determined by a user (e.g., convergence occurs after a set number of training iterations, described below).

In the case of supervised machine learning, the convergence process (184) compares the output (182) to a known result (186). A determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

In the case of unsupervised machine learning, the convergence process (184) may be to compare the output (182) to a prior output in order to determine a degree to which the current output changed relative to the immediately prior output or to the original output. Once the degree of changes fails to satisfy a threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188), but may be a scheme which attempts to guess how the parameter (180) may be changed so that the next execution of the machine learning model (178), using the training data (176) with the updated parameter (190), will have an output (182) that is more likely to result in convergence. (E.g., that the next execution of the machine learning model (178) is more likely to match the known result (186) (supervised learning), or which is more likely to result in an output that more closely approximates the prior output (one unsupervised learning technique), or which otherwise is more likely to result in convergence.)

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1C may be multiple parameters, weights, settings, etc.

During deployment, the trained machine learning model (192) with the trained parameter (194) is executed again, but this time on the input vector (104 of FIG. 1A) for which the final result is not known. The output of the trained machine learning model (192) is then treated as a prediction of the information of interest relative to the unknown data.

While FIG. 1A through FIG. 1C show a configuration of components, other configurations may be used without departing from the scope of the invention. For example, various components may be combined to create a single component. As another example, the functionality performed by a single component may be performed by two or more components.

FIG. 2 shows a method of executing a shallow-deep classification scheme. The method of FIG. 2 may be executed using the system shown in FIG. 1A and FIG. 1B. The machine learning models mentioned in the method of FIG. 2 may be trained using the training controller (134) shown in FIG. 1A and FIG. 1C.

Step 200 includes receiving a natural language query from a user interface of a chatbot. The natural language query may be received at a server from a user device via a network. The user device may display the chatbot user interface. The server may generate the chatbot user interface, and transmit the same to the user device (e.g. via a web browser).

Step 202 includes generating an input vector by performing vectorization on the natural language query. Vectorization is a computer operation that transforms the natural language query into a vector, such as the input vector (104 of FIG. 1A). Vectorization may be performed according to many different methods. For example, information in the natural language query corresponding to pre-determined features may be extracted from the natural language query. Values of the features in the vector may be assigned to the vector according to the information extracted from the vector.

Step 204 includes inputting the input vector to a shallow-deep classifier, wherein the shallow-deep learning classifier includes a classification machine learning model that is programmed to classify the input vector as being one of a shallow machine learning classification problem or a deep machine learning classification problem. As indicated above in FIG. 1A, the shallow-deep classifier takes, as input, the input vector (i.e., the input vector generated at step 202).

Step 206 includes outputting, by the shallow-deep classifier, an output label, wherein the output label includes one of the shallow machine learning classification problem and the deep machine learning classification problem. The training of the shallow-deep classifier permits the machine learning model that constitutes the shallow-deep classifier to output a label. The label is either “shallow,” indicating that the natural language query is a shallow machine learning model classification problem, or “deep,” indicating that the natural language query is a deep machine learning classification problem.

In other words, the shallow-deep classifier does not process the natural language query itself. Rather, the shallow-deep classifier outputs a label that represents whether the natural language query should be processed by a shallow machine learning model (e.g., a chatbot) or a deep classifier (e.g., a deep classifier such as a neural network or a random forest).

Step 208 includes a step of determining whether the output label is a deep machine learning model classification problem. The step of determining may be performed by comparing the label output by the shallow-deep classifier to a test that determines if the output label is shallow or if the output label is deep.

Step 210 includes inputting, responsive to the output label including the deep machine learning classification problem (a “yes” determination at step 208), the input vector to a deep classifier including a deep natural language machine learning model. Inputting may be performed by providing the vector generated at step 202 to the deep classifier.

Step 212 includes outputting, by the deep classifier, an intent classification that represents an intent of the natural language query. Outputting may take the form of one of several pre-determined intents. For example, the deep classifier may be trained to classify a natural language query into one of possibly many different pre-determined intents (e.g., positive, negative, thanks, frustration, anger, etc.). The output of the deep classifier may be machine readable or human readable. For example, the output of the deep classifier may be a vector where the pre-determined intents are features and the value or values of the features indicate the classification of the intent. The value or values may represent probabilities that the natural language query falls in one or more of the different pre-determined intents.

Note step 212 may fail to generate an acceptable intent classification. For example, if the probability that the natural language query is classified in any one of the pre-determined intents fails to satisfy a threshold, then the output of the deep classifier may be “no classification.” Thus, the intent classification may be “no classification,” indicating that the deep classifier failed to generate the intent classification.

Step 214 includes routing, based on the query, either the natural language query and the intent classification to an agent, or routing the input vector and the intent classification to a topic classifier. Step 214 may be considered a decision. For example, if the deep classifier failed to generate the intent classification at step 212, then the natural language query, possibly together with one or more of the most likely intents of the intent classification, may be transmitted to an agent computing system. In this event, the method may terminate thereafter.

However, if the intent classification was successful at step 212 (i.e., at least one of the pre-determined intents had a probability higher than the threshold value), then the input vector and the intent classification are transmitted to a topic classifier. Transmitting may be via a network, or internally within the same processor-executed algorithm.

In this case, the method may proceed from step 214 to step 216. Likewise, returning to step 208, if the output at step 206 is a shallow machine learning classification problem, then the method also proceeds to step 216.

Step 216 includes inputting the input vector (generated at step 202) to a topic classifier. Again, the topic classifier is a classification machine learning model that is trained to determine a topic of the natural language query. The input of the topic classifier is the input vector, and the output of the topic classifier is the topic of the natural language query. Alternatively, the output of the topic classifier is an output vector where the features of the output vector are a set of pre-determined topics, and the values of the features represent the probabilities that the natural language query is one of the pre-determined topics.

Note that it is possible, in the case where the natural language query was found to be a deep machine learning classification problem, to add the intent classification of the natural language query to the input of the topic classifier. The intent classification may be added, for example, by adding the intent classification as an additional feature of the input vector. The value of the intent feature may indicate the intent classification determined at step 212. Thus, when the topic classifier is executed, the topic classifier may take into account the intent of the natural language query when determining the topic of the natural language query.

In any case, step 218 generates outputting, by the topic classifier, a topic of the natural language query. The topic may be the topic (i.e., feature) having the highest probability that the natural language query belongs to a given topic in the output vector.

Step 220 includes selecting, based on the topic, a selected chatbot from among a set of chatbots. Selecting may be performed, for example, by comparing the topic selected for the natural language query to the topics for which the various chatbots are trained. For example, if a chatbot is trained on “Topic 1,” and the output of the topic classifier at step 218 is “Topic 1,” then the selected chatbot is the chatbot trained on “Topic 1” because the output of the topic classifier matches the topic upon which the chatbot was trained.

However, other bases may be used for selecting the selected chatbot. For example, the top set of topics in the output vector at step 218 may be selected. In this case, the three chatbots may each generate a response. The responses are then evaluated by another machine learning model to select one of the chatbot responses to present to the user. In this case, the selected chatbot is the chatbot for which that chatbot's response is to be presented to the user. Still other selection schemes may be used.

Step 222 includes inputting the input vector to the selected chatbot. Thus, the input vector generated at step 202 may be provided to the selected chatbot. In an embodiment, for natural language queries having deep output labels, the intent classification may be added to the input vector. Thus, the intent of a natural language query may be taken into account by the selected chatbot as part of generating the chatbot response.

Step 224 includes returning the chatbot response. The chatbot response may be returned by transmitting the chatbot response to the chatbot user interface of a remote computing system. The chatbot response may be returned by storing the chatbot response, such as, for example, to be used for retraining of the machine learning models described herein. The chatbot response may be returned by transmitting the chatbot response to a display device of an agent computing system. Combinations of the above procedures also may constitute returning the chatbot response. Thus, returning the chatbot response may be more than simply presenting the chatbot response to the chatbot user interface. The method may terminate thereafter.

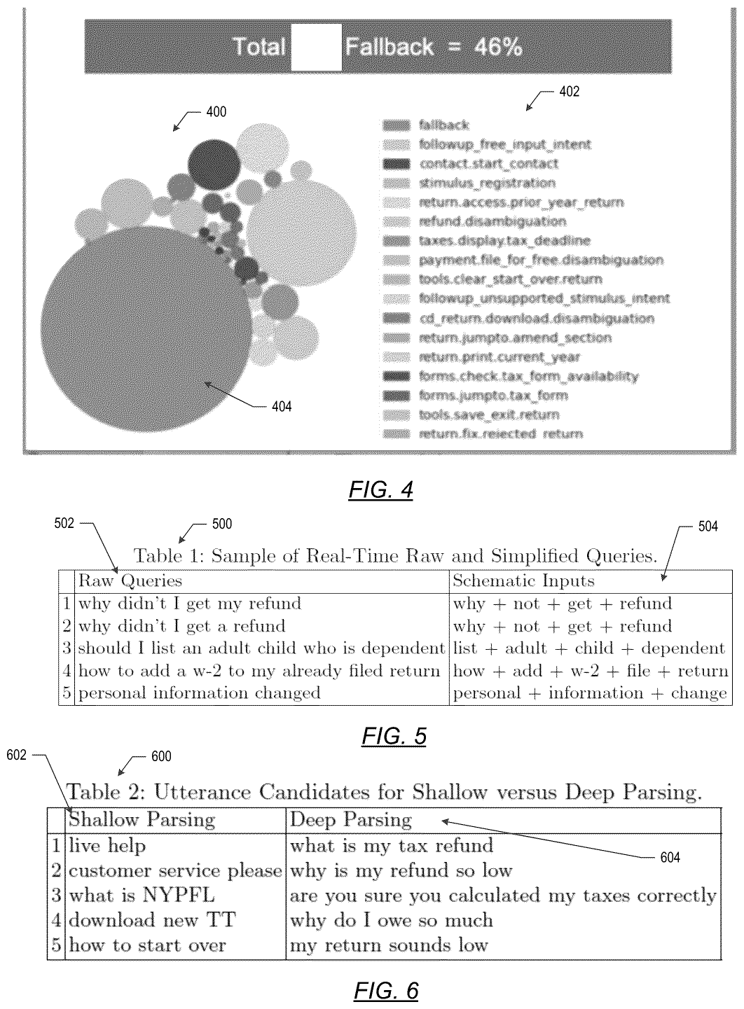

The method of FIG. 2 may be varied. For example, the method may include generating a weighted classification by applying a weight to the intent classification. The weight may be applied by multiplying the value that represents the feature of the intent classification by a number. The number may be selected by a computer scientist. For example, it may be desirable to make it more likely to route user queries having “dissatisfied” intent classifications to agents. The weighting may be used to accomplish this goal. However, weighting may be used for other reasons, for example as further described with respect to FIG. 4 through FIG. 13.

After generating the weighted classification, a comparison may be generated by comparing the weighted classification to a threshold. The intent classification is then routed based on the comparison, such as in the example above. However, routing also may include, responsive to the comparison failing to satisfy the threshold, transmitting the natural language query and the intent classification to a display device of an agent.

Routing also may include, responsive to the comparison satisfying the threshold, transmitting the input vector and the intent classification to a topic classifier including a topic classification machine learning model. In this case, the method also may include generating, automatically using the topic classifier, a chatbot response to the natural language query; and transmitting the chatbot response to a user device.

In still another embodiment, routing may include, responsive to the comparison satisfying the threshold, transmitting the input vector and the intent classification to a topic classifier including a topic classification machine learning model. In this case, the method also may include classifying, by the topic classifier, a topic of the natural language query. The method then also includes selecting, from among a group of chatbots and based on the topic, a selected chatbot. The method then also includes generating, automatically by the selected chatbot and based on the intent classification of the natural language query, a chatbot response to the natural language query. The method then includes transmitting the chatbot response to a user device. The method may terminate thereafter.

An integrated example of using a weighted classification is now presented. The method also includes inputting, responsive to the output label including deep, the input vector to a deep classifier which is a deep natural language machine learning model. The method also includes outputting, by the deep classifier, an intent classification that represents an intent of the natural language query. The method also includes generating a weighted classification by applying a weight to the intent classification. The method also includes generating a comparison by comparing the weighted classification to a threshold. The method also includes transmitting, responsive to the comparison satisfying the threshold, the input vector and the intent classification to a topic classifier including a topic classification machine learning model. The method also includes classifying, by the topic classifier, a topic of the natural language query. The method also includes selecting, from among a plurality of chatbots and based on the topic, a selected chatbot. The method also includes generating, automatically by the selected chatbot and based on the intent classification of the natural language query, a chatbot response to the natural language query. Finally, the method also includes transmitting the chatbot response to a user device.

Still other examples are possible. Thus, the one or more embodiments are not limited to the samples provided above.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

FIG. 3 through FIG. 13 show examples of the machine learning system described with respect to FIG. 1A, FIG. 1B, and FIG. 1C, and variations on the method shown in FIG. 2. The following examples are for explanatory purposes only and not intended to limit the scope of the invention.

Attention is first turned to FIG. 3, which shows an architecture for a shallow-deep classification system for use with multiple chatbots. The architecture of FIG. 3 may include a communication device (300). The communication device (300) may receive one or more queries, such as query (302). The query (302) may be one or more natural language queries, such as the natural language query (102 of FIG. 1A). The query (302) may be received from a user device (304) that is to interact with a chatbot (described below).

In an embodiment, a rewording controller (306) may reword the queries prior to identification. For example, the rewording controller (306) may perform pre-processing of the query (302) in order to change the phrasing of the queries to remove extraneous words (e.g., pauses, verbal tics, articles, etc.). The rewording controller (306) also may perform other text normalization procedures, such as lemmatization or stopword deletion.

In any case, the query (302) (whether reworded by the rewording controller (306) or not) are provided to a shallow-deep classifier (308). The shallow-deep classifier (308) may be the shallow-deep classifier (148 of FIG. 1B) and may perform similar functions as described with respect to FIG. 2, step 204. Thus, the output of the shallow-deep classifier (308) may be either a deep label (310) or a shallow label (312), meaning that the query (302) is either a deep machine learning classification problem or a shallow machine learning classification problem.

The deep label (310) further means that deep natural language understanding, such as semantic parsing by a deep classifier, is to be used to surface the meaning with or without further alignment with intent classification. When the output of the shallow-deep classifier (308) is the deep label (310), then the query (302) is transmitted to a deep classifier (314). The deep classifier (314) then classifies the query (302) and generates a predicted meaning of the query (302).

In an embodiment, the output of the deep classifier (314) may be transmitted to a weight controller (316). The weight controller (316) may weight the classification of the meaning of the query (302) which had been output by the deep classifier (314). Additional information regarding weighting is provided below.

The output of the weight controller (316) (or the deep classifier (314), if the weight controller (316) is not used) is a topic an intent candidate (318). The topic and intent candidate (318) is provided to a topic classification model (320).

The topic classification model (320), in turn, categorizes the topic and intent candidate (318) into one of a number of pre-determined topics. The topic categorization operation of the topic classification model (320) is also performed on the shallow label (312), in the case that the shallow-deep classifier (308) classifies the query (302) as being the shallow label (312) (i.e., a shallow machine learning model classification problem). The shallow label (312) means that intent classification is sufficient to estimate the gist of the query (302).

The topic is then used to select one of a set of chatbots, which in FIG. 3 include the chatbot 1 (322), the chatbot 2 (324), and the chatbot 3 (326). More or fewer chatbots may be present. The query (302) is then sent to a selected chatbot that corresponds to the topic determined by the topic classification model (320). In other words, the topic of the query (302) is used to determine which chatbot will process the query (302). Each chatbot is a machine learning model trained to respond to a different topic, in order to increase the likelihood that the response provided to the user accurately reflects a valid answer to the query (302) provided by the user.

As shown, the chatbots take, as input, the topic classification model (320) and generates, as output, an intent classification. The chatbot 1 (322) outputs the intent classification 1 (328), the chatbot 2 (324) outputs the intent classification 2 (330), and the chatbot 3 (326) outputs the intent classification 3 (332). In each case, the intent classification reflects an intent of the query (302). Note, however, that in an embodiment not all three of the intent classifications are generated. Instead, in this example, in order to conserve computing resources, just the selected chatbot generates the corresponding intent classification.

Then, the corresponding chatbot generates a response to be sent back to the user device (304), based on the corresponding intent classification. Thus, as shown, the chatbot 1 (322) generates the response 1 (334), the chatbot 2 (324) generates the response 2 (336), and the chatbot 3 (326) generates the response 3 (338). Note, however, that in an embodiment not all three of the responses are generated. Instead, in this example in order to conserve computing resources, just the selected chatbot generates the response.

The final response (340) is the response generated by the selected chatbot. In the alternative, in an embodiment, it is possible that some or all of the chatbots may generate a corresponding response. In this case, another machine learning process or a non-machine learning algorithm may select among the responses to determine the final response (340).

In any case, the final response (340) is transmitted to the user device (304). The final response (340) is displayed on a display device of the user device (304).

Returning to the operation of the deep classifier (314), the deep classifier (314) may fail to generate an intent of the query (302) having an accuracy value within a pre-determined accuracy value. For example, the deep classifier (314) may output not only an intent of the query (302), but an accuracy value that represents a predicted probability that the output of the deep classifier (314) accurately reflects the intent of the query (302).

In this case, the query (302) and possibly other information may be transmitted to an agent computing device (342). The other information may include the predicted intent of the query, even if the determined accuracy of predicted intent did not satisfy the pre-determined threshold value. The other information also may include information that identifies the user operating the user device (304) or information included in a user profile associated with the user using the user device (304).

In an embodiment, the conversation between the agent computing device (342) and the user device (304) may be recorded. Together with the predicted intent, predicted accuracy value, and possibly the other information, the transcribed conversation may be used as training data to further improve the accuracy of the deep classifier (314) during periodic re-training of the deep classifier (314).

Description regarding FIG. 3 is now provided. One or more embodiments relate to a technique for deciding, given a customer-service chatbot architecture, which incoming customers' queries to route to a deep classifier, and which to route to an understanding module for deeper semantic analysis. The method allows for discriminating between queries (word embeddings) that look closely-related on the surface but have different meanings. For example, the question ‘What is a tax refund’ is closely related to the question ‘What is my tax refund,’ but the meanings are different.

Given a domain, one or more embodiments classifies a query characterized by a distinct set of features into one of two prescribed classes—shallow or deep. For some queries, shallow parsing or intent classification is enough; for others, deep semantic analysis is needed to surface the most likely interpretation to trigger appropriate actions by the chatbot executor. The routing of queries to distinct natural language unit components early in a chatbot conversational flow improves the conversational flow between customers and chatbots by decreasing circular conversations, unnecessary clarifications, misinterpretations, and query repetitions. Further, the method helps content creators to better craft answer policies and strategies for the chatbot executor in the presence of these domain language features.

In particular, one or more embodiments provide for weighting the meaning import of content, as well as non-content, words to direct incoming queries either to a shallow natural language understanding machine learning model (sNLU) that is intent-based or to a deep natural language understanding machine learning model (dNLU) that performs deeper semantic analysis. After the deeper analysis, language feature aggregation weights are used to reroute queries (original or reworded) either to request live help straightaway or to topic and intent classification so as to leverage existing answers. Queries labeled as “deep” that are rerouted to live help are automatically saved along with their analysis to help chatbot developers with training data and with improving on conversational flows.

The example of FIG. 3 may be highlighted by way of a specific example in which the chatbots shown are chatbots programmed to answer, automatically, user queries about tax related issues. Text-based customer-service chatbots are software applications that enable customers to request help and have queries answered in a conversation-like manner instead of interacting with live human agents.

Typically, such chatbots are domain-specific and thus specialized to provide answers relevant to the domain at hand Ideally, these chatbots simulate how humans converse about the domain topics, including how and which information is gathered and conveyed, and how questions are to be interpreted and answered. The chatbots are designed to streamline conversational customer interactions, which should not only improve customer experience but also reduce costs and interaction times for both customers and agents. Customer-service chatbots built on intents purport to capture the meaning of queries by aligning queries with predefined domain labels curated by humans to trigger responses towards some goal within an application. Intent classification ignores the complexity of language: it reduces the many surface language variations of a presumed query meaning to meaning-encompassing labels.

In one version of a tax-domain chatbot, the utterances of the user (see FIG. 6 for an example of utterances) have identical predicted intents, and thus the chatbots produce identical answers. However, two of the utterances have precisely the opposite predicted intent. Consider the following utterances with different meanings, but having identical predicted intents:
a) “great! thanks” Predicted Intent: Positive feedback
b) “really thanks a lot for nothing” Predicted Intent: Positive feedback
c) “thats wrong. thanks a lot” Predicted Intent: Positive feedback
d) “thanks for not answering” Predicted Intent: Positive feedback

As can be seen from the above examples, present-day chatbot performance leaves much to be desired.

Design efforts concentrate on improving chatbot conversational flows and making chatbots more human-like by adding anthropomorphic design elements. For instance, when conversations break down, chatbots may be designed to acknowledge that they are clueless or responsible for miscommunication, or they might provide options for moving forward by asking customers to rephrase the query or to consult similar domain topics with additional web searches. Despite strategies to design chatbots as humble, mistake-prone conversational participants, interactions with chatbots remain frustrating as customers expect chatbots to understand what they are writing as well as to be the ultimate experts in problem resolution.

One source of customer frustration is the failure of a chatbot to understand the language that customers are using to describe their issues. For example, after submitting the query ‘What is my tax refund’ to a tax-domain customer-service chatbot, a customer reacts to the chatbot answer with ‘don't care about tax refund in general. Google can tell me that! Want to know what is MY refund!!!!!’. While the chatbot recognizes ‘refund’ as the candidate intent when answering back with a definition of ‘tax refund,’ it nevertheless fails to understand that the query of ‘refund’ relates to the customer scenario as indicated by the possessive ‘my’. Next, to the customer's conversational closing statement ‘This is the thanks you get: None’, the chatbot replies ‘Glad I could help!’ The unrelenting customer goes on with ‘You are dumb!’ The friendly chatbot responds ‘You are welcome.’ The conversation leaves the customer feeling as if the service being provided is substandard and worthless, which is undesirable to the tax preparation software provider.

Attention is turned to the technical reasons failure of the chatbot. While the chatbot understands the query to be on the topic of ‘refund,’ the chatbot fails to weigh, and thus discriminate, a deeper layer of meaning between general and specific refund. Next, the chatbot latches onto the content word ‘thanks’ as an expression of positive experience and fails to detect the negative import of the word ‘none.’ Finally, given the conversational flow, the utterance type of the customer's parting words are interpreted de facto as appreciative closing words.

Intent-based chatbots may consume words that are nouns or verbs in their canonical form. Such words may be considered to be the relevant meaning-bearing inputs upon which to train the chatbot machine learning models.

Consider the following examples:
Example a): I should claim my adult child on return, no?
   Predicted Intent-Relevant: claim+adult child+return
Example b): I claimed my adult child on return.
   Predicted Intent-Relevant: claim+adult child+return

In the above example, the content words for intent detection are identical in (a) and (b). However, in (a), the customer is asking whether it is recommended that an adult child be claimed on tax return. This recommendation should be evaluated given the customer tax scenario. In (b), the query is not a request on how to claim an adult child, but it is a statement of fact, which is conveyed by the ‘-ed’ ending on the word ‘claim.’

Consider the queries the third example, below.
Example a) why didn't I get a refund?
   Intent-Relevant: why+not+get+refund
Example b) why didn't I get my refund?
   Intent-Relevant: why+not+get+refund

Assume a standard intent model with stopword deletion and lemmatization, but ‘negation’ preserved. For intent classification, (a) and (b) are identical utterances. However, deep semantic analysis shows that (a) is an indirect request for an explanation as to why customer did not receive a refund, while (b) is ambiguous between a request for a status update and two indirect speech acts, namely, the customer's expectation of refund is not met and customer requests explanation.

With both qualitative and quantitative analyses (or domain corpus profiling), the language signals that convey discrete, granular meaning (feature engineering) are surfaced to create language models that are biased to non-content as well as content tokens. One or more embodiments provide a statistical shallow-deep classifier to distinguish between queries that (1) align with a domain intent classification and those that (2) require deeper semantic analysis. Further, this multi-layered machine learning approach is positioned into the multi-bot chatbot architecture of FIG. 3 to improve query understanding, and thereby increase the likelihood of action-oriented task completion for customers.

As shown in FIG. 3, first queries may be sent to the rewording controller (306) to improve on the quality of the queries. Note that text normalization performs neither lemmatization nor stopword deletion since language units (content and non-content units) are considered relevant to meaning.

Second, reworded queries go to the shallow-deep classifier (308). Queries classified with the shallow label (312) are routed to the domain-specific, topic classification model (320). Topics are broad categories of domain themes (or umbrella topics). Each of the domain umbrella topic has its own chatbot (training data and model) with corresponding intent classification.

Queries classified with the deep label (310) are subject to deep semantic analysis by the deep classifier (314). For a given interpretation, language features are aggregated and weighted by the weight controller (316) to decide where to reroute the query. The query either can be a candidate for topic and intent classification (i.e., the topic and intent candidate (318) is sent to the topic classification model (320), as mentioned above), or be embedded into a request for live help (i.e., transmitted to the agent computing device (342), as mentioned above).

Various external resources may be made available to the shallow-deep classifier (308). For example, domain lexicons and terminologies in machine-readable format associated with the language of the written queries may be provided. In another example, published texts relevant to the domain may be provided. Such texts may be grammatical and written for human consumption in the relevant language. Such texts can be automatically consulted to check for occurrences of reworded queries or phrases in queries. In still another example, third-party libraries may be provided. The third-party libraries may provide datasets pertinent to various natural-language tasks for the language of the queries (part-of-speech tagging, multi-word detection, selection restrictions, entity extraction, etc.)

In addition to the procedure described above, FIG. 3 provides for pre-processing. Pre-processing may include corpus profiling from data observations to data labeling. Corpus analyses is used for corpus-profiling purposes and feature engineering to train various language features to classify queries. Corpus analyses give insights as to the distribution and statistical relevance of those features (statistically-based measures). Data observations through corpus analyses inform feature creation and selection.

Feature selection may be performed to identify substantive language features. Consider the following example in one tax-domain corpus.

The statistical analyses indicate that the more substantive language features are as follows:
Negations (‘not’, ‘never’, ‘nontaxable’, ‘wrong’, etc.)
Temporal expressions (duration versus punctual)
Verb tenses
Wh-words (‘why’, ‘where’, etc.)
Possessive pronouns
Comparisons
Word order
Temporal and/or spatial prepositions
Quantifiers (‘a’, ‘any’, ‘some’, none, etc.)
Number of tokens in query
Number of terms or multiword expressions in query

A feature evaluation method may involve an evaluation of which features are important to semantic meaning Six methods may be used to rank features and a union of most prominent features among these methods are used, including ridge regression, mutual information, feature weights of classifiers, feature correlations with each other, feature correlations with labels, and observations from data labeling.

For one tax-domain corpus, the most salient features include ‘num tokens’, ‘num poss’, and ‘contains wh word.’ While some features may perform poorly, these feature evaluation methods give scores dependent on the data distribution. Therefore, features that seem weak can still be used in training as they might be relevant for customer queries under certain contexts.

In a customer-service chatbot, it is much more damaging for a deep query to be misclassified as a shallow query compared to the other way around. The metric of choice is recall. The metric is a measurement of the accuracy of the shallow-deep classifier (308). The goal of training the shallow-deep classifier (308) may be to minimize false negatives; thus, the deep label (310) may be considered the positive label.

The shallow-deep classifier (308) may be a non-linear method, such as a random forest classifier. The shallow-deep classifier (308) may use the selected features for the classification of utterances as having the deep label (310) or the shallow label (312). Cross-validation is used as a re-sampling method to test and train the model. Hyperparameter selection has been used to avoid overfitting.

The shallow-deep classifier (308) within the multi-bot architecture may provide the additional benefit of generating automatically natural-language-analysis insights for the queries having the deep label (310) that are routed to the agent computing device (342) for live help. Such queries, along with their semantic analysis and features, may be automatically appended to a log file for developers to. The queries and log file may be used for a variety of purposes, such as but not limited to defining and refining intents, use as training data, refining answer types given features, refining conversational flow, and others.

As shown above, with both qualitative and statistical analyses, one or more embodiments may surface language signals in domain queries that convey discrete, granular meaning to create language machine learning models that are biased to non-content as well as content tokens. The shallow-deep classifier (308) is built to distinguish between queries that (1) align with a domain intent classification and those that (2) require deeper semantic analysis. Further, the shallow-deep classifier (308) is placed into a multi-bot chatbot architecture to improve query understanding, as explained above. Thus, one or more embodiments may increase the likelihood of action-oriented task completion for users.

Attention is now turned to FIG. 4 through FIG. 13, which provide for another example. The example of FIG. 4 through FIG. 13 reflects a specific example of the architecture of FIG. 3 in use. Thus, the example of FIG. 4 through FIG. 13 also reflects a specific example of the system of FIG. 1 and the method of FIG. 2 in use.

FIG. 4 illustrates the technical problem described above when using a machine learning chatbot system without the system of FIG. 1A through FIG. 1C, the method of FIG. 2, and the system of FIG. 3. FIG. 4 represents the fallback rate for a real chatbot system used by chatbots supporting a tax preparation software.

The bubble graph (400) illustrates the average fallback rate for the machine learning system. Fallback occurs when the chatbot fails to resolve a user query, and the “fallback position” is to route the query to a live customer service agent or to user boards for additional user support.

The legend (402) represents the category of question which was resolved. As shown by the large bubble (404), fallback represents the single largest result of the chatbot system. Specifically, random recurrent data analyses to monitor accuracy of intent classification over four months suggests that the unaided chatbot system plateaus at 46% of fallback intent. Furthermore, the unaided chatbot system too often rerouted customers to domain forums to seek answers to their questions, did not understand queries that are not subject to direct and literal interpretations, and routinely requested customers to rephrase their original queries. This result was deemed undesirable.

Text-based customer-service chatbots do not constrain the language of users, though users can and do write in prescriptive, telegraphic, allegorical, sarcastic, or ungrammatical English. Such expressions further can be interspersed with emojis and diacritics to convey emotions. These non-textual signals are interpreted poor by chatbots. The vast, open-ended range of textual quality of raw queries strongly suggest that maximizing speed of communication trumps language prescriptions. Though one might think language prescriptions would be more useful to a linguistic construction for grammatical and semantic completeness, words and phrases input to real chatbots routinely omit grammatically correct words if customers assume they are shared with or easily filled by the chatbot.

The intent-based paradigm may be considered telegraphic. Intent-based, text-based chatbots rely on content words as the source of meaning for customers' utterances. With intents, meaning is an approximation of what is said and is considered sufficient to generate a response. As long as there are content words, the quality of the language inputs should not impact intent detection as classifiers learn to favor content words for meaning. The language models are built on nouns and verbs with the exception of some adjectives and adverbs.

FIG. 5 shows a table (500) of raw queries (column 1 (502)) and associated schematic inputs (column 2 (504)) which are built from the raw queries. The example of FIG. 4 through FIG. 13 assumes that each of the raw queries (column 1 (502)) for the chatbot are simplified to the schematic inputs (column 2 (504)). The function words and inflections like determiners, conjunctions, prepositions, auxiliaries, possessives, plurals, tenses, etc., have been stripped from the inputs to be processed for meaning.

As shown in FIG. 5, query 1 and query 2 share identical chatbot representations. Thus, the chatbot is prompted to assign an intent of status update to both queries. However, only query 1 is a request for a status update. To generate an appropriate answer to query 2, the chatbot would have to leverage the meaning from the possessive word ‘my’ and from the indefinite determiner word ‘a’, respectively. The word ‘my’ functions as a definite operator that points to the referent word ‘refund’, whose existence is assumed as fact by the customer. The customer filed their taxes and the outcome of the calculations summed up to a refund. The user is asking for a status update in query 1. On the other hand, for query 2, the indefinite quantifier word ‘a,’ in the scope of the negation word ‘not,’ is an indirect request to explain why the customer did not qualify for a refund, which involves checking the customer's tax scenario. Thus, query 1 and query 2 in FIG. 5 ask entirely different questions, which the chatbot interprets as identical questions. Such a result is not desirable, because in the case of query 1 the chatbot will return an incorrect answer that frustrates the user.

With query 3, the chatbot returns a fallback with possible suggestion links about adult children and taxes. The reply to query from the user may be, ‘I don't care about it; I want to know if best for me.’ Note that the query is not grammatically correct. Thus, the chatbot fails to detect that the query is about the best course of action for the customer given their tax scenario. The word ‘should’ conveys the sense of recommendation in original raw query, a fact that the chatbot does not detect. Thus, again, the chatbot returns an incorrect answer, which frustrates the user.

With query 4, the chatbot no longer has the tense or time features available like the suffix ‘-ed’ and the adverb ‘already’ that point to a past action and state of fact. The chatbot therefore returns an answer regarding how to add W-2 information to a tax return which has not been filed yet, rather than how to handle the situation when the tax return already has been filed and the W-2 information is to be added late. Accordingly, again, the chatbot returns an incorrect answer, which frustrates the user.

Finally, in query 5, the removal of the suffix ‘-ed’ triggers the chatbot to interpret the query as a request regarding how to change the user's personal information on the user's software account, instead of interpreting the input as a fact that will change the user's tax return. Accordingly, again, the chatbot returns an incorrect answer, which frustrates the user.

The examples in Table 1 (500) of FIG. 5 strongly suggest that non-content language units directly contribute to what customers intend to convey in their queries. Therefore, meanings of the inputs should be captured as precisely and accurately as possible.

The techniques described with respect to FIG. 1A through FIG. 3 may be used to discover language features that serve as signals to whether a shallow intent classification is sufficient to determine the gist of the query accurate, or whether a query warrants a deeper natural language understanding to determine the user's intent accurately. In this example, there is no interest in superficial features, such as misspellings and non-standard grammar types. Rather the determination of interest is whether some features correlate with some utterance types, which may play specific domain functions in the conversational flow.

The example approaches the problem as a binary classification task, that of classifying customer utterances as either shallow or deep. More precisely, a shallow classification label means existing intent classification available to the chatbot is sufficient for the chatbot to understand a customer message. A deep classification label means that a deeper natural language understanding, such as semantic parsing, is useful to represent utterance meaning with or without alignment with existing predefined intents. Once the deeper natural language understanding is obtained from a deep classification machine learning model, then that understanding may be passed to the chatbot for processing.

Consider the utterance candidates for shallow versus deep parsing, shown in table 2 (600) of FIG. 6. Given real-world customer queries, there is a subset of utterances that shallow machine learning models may process, and another that may be better processed by deep classifiers. As can be seen, the utterances in column 1 (602) are easy for a chatbot (a shallow machine learning model) to parse, but the utterances in column 2 (604) are difficult for a chatbot to parse (suggesting the use of a deep semantic machine learning model to parse the utterance). Note that while the utterances in column 2 (604) are simple for a human to understand, a machine learning model will have difficulty understanding those utterances because of qualifying words such as “my,” “so,” “I,” and “sounds.”

Several considerations are taken into account when approaching the problem of distinguishing whether an utterance is a deep machine learning classification problem or a shallow machine learning classification problem. One consideration is determining which language features (form+meaning) determine if a customer's message requires deeper understanding. Another consideration is determining how accurately can a machine learning model determine if a customer message desires a deeper understanding. Another consideration is determining what proportion of customer messages warrant deep understanding. Other considerations exist.

The example of FIG. 4 through FIG. 13 represents a previously undisclosed experiment. The corpus included about 500,000 customer queries with ‘fallback intent’ collected from a chatbot dashboard. The queries are raw and have not been edited. Single queries may include a number of words between a single word up to around a hundred words. Queries included single and multiple utterances.

A prior corpus analysis for corpus-profiling purposes suggest that utterances that benefit from deeper machine learning models have combinations of the following characteristics: Negations (‘not’, ‘never’, ‘nontaxable’, etc.); temporal expressions (duration versus punctual); verb tenses; “Wh-‘words (‘why’, ‘where’, etc.); possessive pronouns; comparisons; temporal or spatial prepositions; quantifiers (‘a’, ‘any’, ‘some’, none, etc.); number of tokens in the query; number of terms or multiword expressions in query (‘climate leadership adjustment rebate’ or ‘nonrefundable tax credit rate,’ etc.)

Notably, most of these characteristics are not related to content words, which shallow intent classification favors. However, the features hold enough meaning to significantly change the frame of user queries.

Given these observations, data was labeled as ‘deep’ if the query contained function words or linguistic features that are ignored by chatbot deep classifiers. Otherwise, the query was labeled as ‘shallow’. In one variation, as few as six of the above characteristic words could be used to route queries to deep learning natural language machine learning models/

Data observations were used to inform feature creation and the selection of twelve features, shown in FIG. 7. The more substantive language features include the following: ‘num poss’—number of possessive pronouns; ‘num future’—number of future tense verbs; ‘contains time term’—indicates presence of a temporal adverb or expression (‘before’, ‘after’, ‘later’, etc.); and ‘num mwe’—number of terms or multiword expressions (determined through dependency parsing, examples include ‘post office’ and ‘phone number’).

These features may be based on data labeling and observation processes. Most of these features account for the meaning that is lost when standard intent classification ignores stopwords, uses lemmatization, or focuses too much on content words.

For feature evaluation, the following methods were used: ridge regression; mutual information; feature weights of classifiers; feature correlations with each other; feature correlations with labels; and observations from data labeling. Other methods may be used.

The feature relevance can be seen in the charts for mutual information scores (700) in FIG. 7 and in the random forest feature weights (800) in FIG. 8. The most salient features include ‘num tokens’, ‘num poss’, and ‘contains wh word.’

Note that, while some features performed poorly, these feature evaluation methods give scores dependent on the data distribution. Therefore, features that seem weak (like ‘num future’) are likely still important for customer queries under certain contexts.

Attention is now turned to classification. The classification may be characterized as a binary classification task that uses the labels ‘shallow’ and ‘deep’ to indicate whether a customer query needs shallow or deep classifiers. In a customer-service scenario, it is much more damaging for a deep query to be misclassified as a shallow query compared to the other way around. Therefore, the metric of choice was that of recall to minimize false negatives. Accordingly, the ‘deep’ label was considered the positive label.

For this exploration, final performance metrics were gathered by training on 50,000 samples and testing on a gold standard set of 2500 samples. The three models used were logistic regression (linear method), random forest (nonlinear method), and ridge regression (primarily for feature evaluation). All three have easily-interpretable feature weights. Cross-validation and hyperparameter search were used as well.

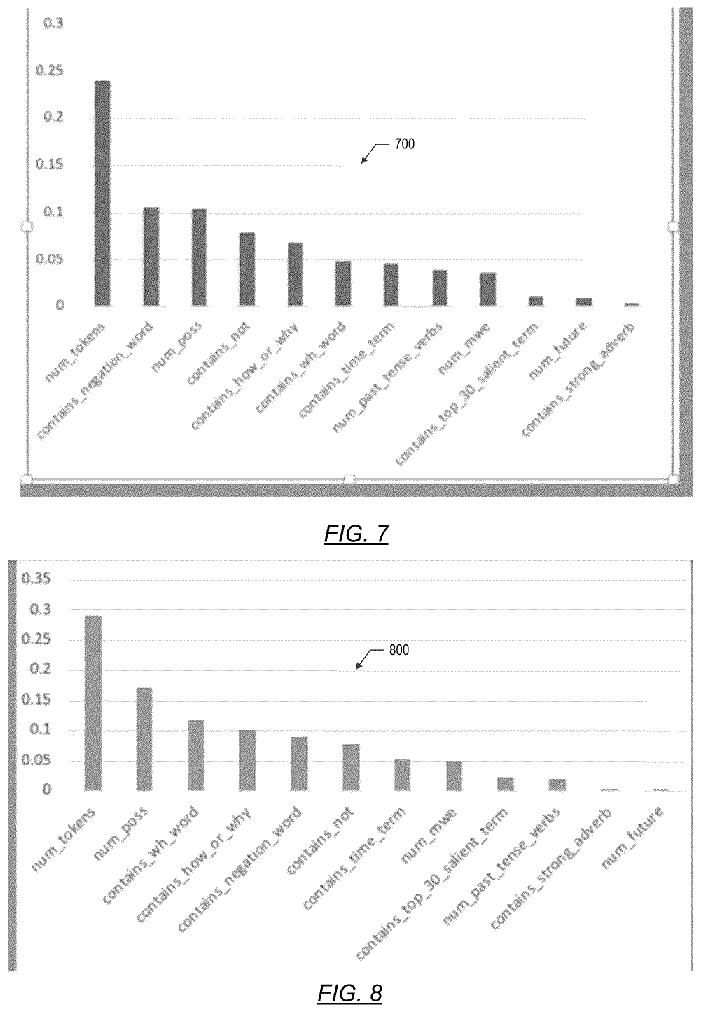

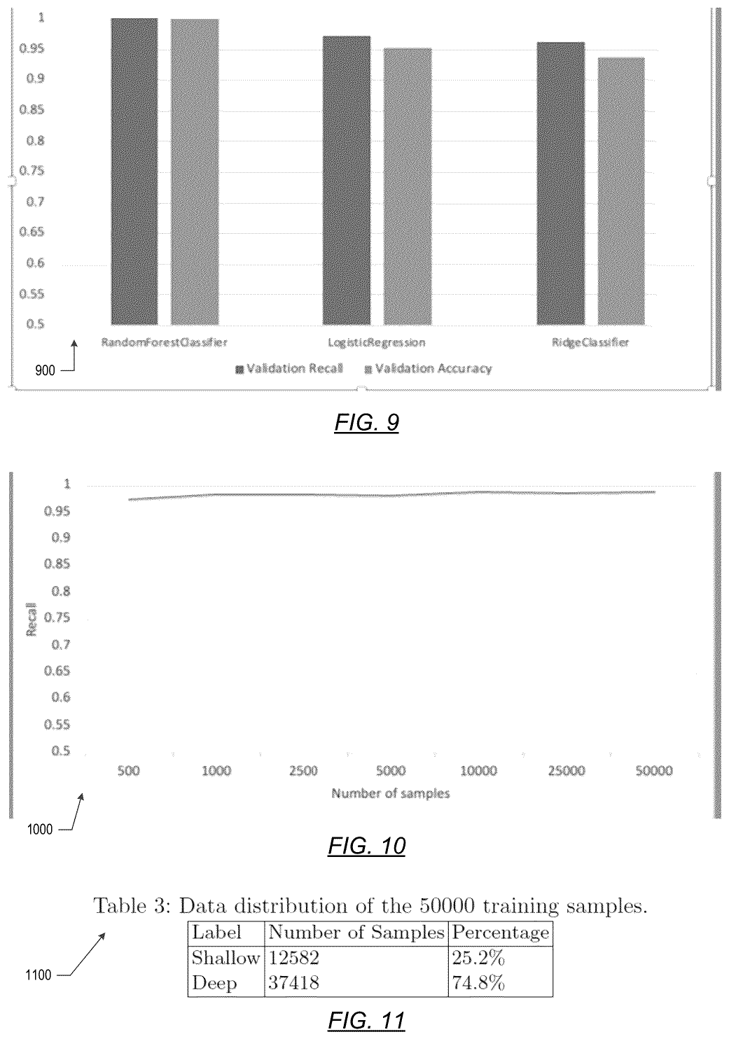

As seen the bar graph (900) of FIG. 9, the random forest machine learning model has the best performance, slightly outperforming the logistic regression machine learning model. Hyperparameter search in the random forest machine learning model also tends to select for a low number of estimators, indicating the random forest machine learning model may have overfit less than the logistic regression machine learning model.

Attention is now turned to data collection and data distribution analysis. First, a dataset of 2500 gold standard customer queries were manually labeled as ‘shallow’ or ‘deep.’ A classifier machine learning model was trained on these labels using the set of language features. The set of language features was subsequently used to label another 50000 training samples. Finally, this last training set was used to train the final classifier.

Training sets of varying sizes were used. Training data size did not affect performance very much. As shown in the graph (1000 of FIG. 10), varying the training data size from 500 to 50000 had little effect on gold standard recall. This result suggests that the task may not use large amounts of data and may be a simple classification task overall.

The data distribution of the training samples can be seen in Table 3 (1100 of FIG. 11). As shown in FIG. 11, almost 75% of queries are considered deep, demonstrating the usefulness of deep classifiers.

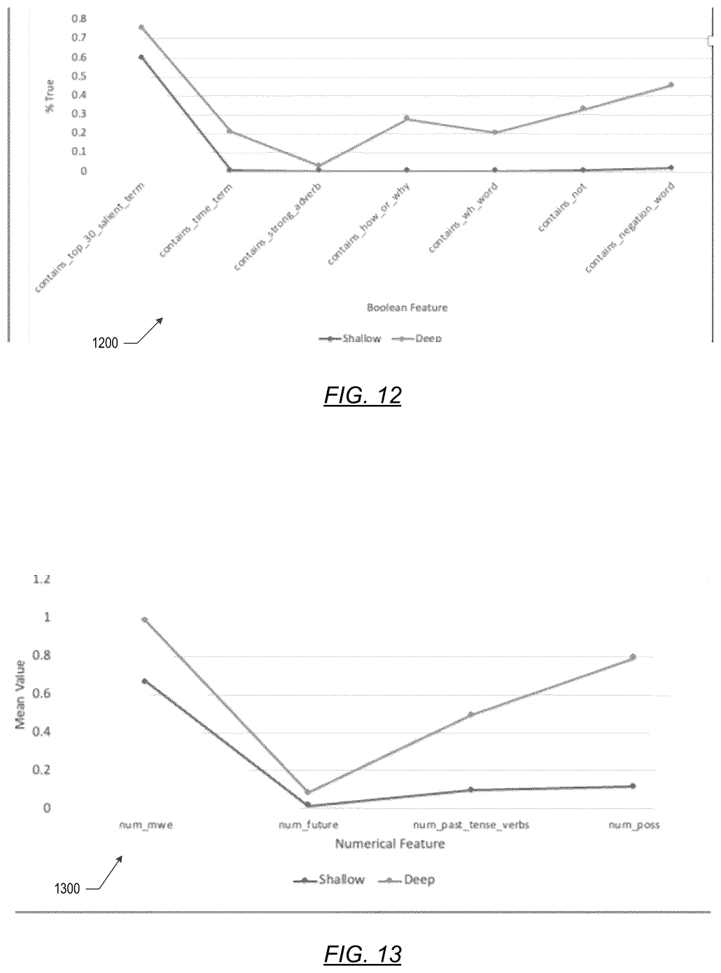

Graph (1200 of FIG. 12) and graph (1300 of FIG. 13) show the distribution of features based on the labels. For the most part, queries labeled as “shallow” had little activation on most features compared to queries labeled as “deep.”

The language features that determine if a user's query should be submitted to a deep classifier include a variety of dimensions, in isolation or together. The dimensions include words that contain possessive pronouns or negation words. The model performed at 98% accuracy and 98% recall on the gold standard dataset. Therefore, the model and data support the idea that real-world user messages can be split into a subset of utterances for which shallow machine learning models is sufficient to obtain the underlying meaning of an utterance, but a subset of utterances should be routed to deep classifiers to obtain the underlying meaning of an utterance.

Shallow understanding of utterances like ‘human now’ or ‘how to start return over’ is enough to get the intent across. In the first case, the user is asking for live help; in the second, the user desires instructions to file from scratch. The utterances are direct requests.

However, consider the following user query: ‘why is my refund low? it was higher last year.’ For this query, the comparison between the implied term ‘current year’ and the used term ‘last year,’ and the implicit comparison in refunds between the two words created by the terms ‘low’ and ‘higher,’ function as an indirect request for a customer-specific explanation of current-year candidate refund. In this case, deep classifiers is more useful to surface the request.

Overall, the idea of using deep classifiers has high potential impact, considering that about 75% of customer messages contain language features that warrant some level of deep understanding according to the training data distribution. See Table 3 (1100) in FIG. 11.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 14A, the computing system (1400) may include one or more computer processors (1402), non-persistent storage (1404), persistent storage (1406), a communication interface (1412) (e.g., Bluetooth interface, infrared interface, network interface, optical interface, etc.), and numerous other elements and functionalities that implement the features and elements of the disclosure. The computer processor(s) (1402) may be an integrated circuit for processing instructions. The computer processor(s) may be one or more cores or micro-cores of a processor. The computer processor(s) (1402) includes one or more processors. The one or more processors may include a central processing unit (CPU), a graphics processing unit (GPU), a tensor processing units (TPU), combinations thereof, etc.

The input devices (1410) may include a touchscreen, keyboard, mouse, microphone, touchpad, electronic pen, or any other type of input device. The input devices (1410) may receive inputs from a user that are responsive to data and messages presented by the output devices (1408). The inputs may include text input, audio input, video input, etc., which may be processed and transmitted by the computing system (1400) in accordance with the disclosure. The communication interface (1412) may include an integrated circuit for connecting the computing system (1400) to a network (not shown) (e.g., a local area network (LAN), a wide area network (WAN) such as the Internet, mobile network, or any other type of network) and/or to another device, such as another computing device.

Further, the output devices (1408) may include a display device, a printer, external storage, or any other output device. One or more of the output devices may be the same or different from the input device(s). The input and output device(s) may be locally or remotely connected to the computer processor(s) (1402). Many different types of computing systems exist, and the aforementioned input and output device(s) may take other forms. The output devices (1408) may display data and messages that are transmitted and received by the computing system (1400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (1400) in FIG. 14A may be connected to or be a part of a network. For example, as shown in FIG. 14B, the network (1420) may include multiple nodes (e.g., node X (1422), node Y (1424)). Each node may correspond to a computing system, such as the computing system shown in FIG. 14A, or a group of nodes combined may correspond to the computing system shown in FIG. 14A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1400) may be located at a remote location and connected to the other elements over a network.

The nodes (e.g., node X (1422), node Y (1424)) in the network (1420) may be configured to provide services for a client device (1426), including receiving requests and transmitting responses to the client device (1426). For example, the nodes may be part of a cloud computing system. The client device (1426) may be a computing system, such as the computing system shown in FIG. 14A. Further, the client device (1426) may include and/or perform all or a portion of one or more embodiments of the invention.

The computing system of FIG. 14A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a natural language query from a user interface of a chatbot;
generating an input vector by performing vectorization on the natural language query;
inputting the input vector to a shallow-deep classifier, wherein the shallow-deep learning classifier comprises a classification machine learning model programmed to classify the input vector as being one of a shallow machine learning classification problem and a deep machine learning classification problem; and
outputting, by the shallow-deep classifier, an output label, wherein the output label comprises one of the shallow machine learning classification problem and the deep machine learning classification problem.

2. The method of claim 1, further comprising:
responsive to the output label comprising the shallow machine learning classification problem, inputting the input vector to a topic classifier; and
outputting, by the topic classifier, a topic of the natural language query.

3. The method of claim 2, further comprising:
selecting, based on the topic, a selected chatbot from among a plurality of chatbots;
inputting the input vector to the selected chatbot; and
returning a chatbot response.

4. The method of claim 1, further comprising:
inputting, responsive to the output label comprising the deep machine learning classification problem, the input vector to a deep classifier comprising a deep natural language machine learning model; and
outputting, by the deep classifier, an intent classification that represents an intent of the natural language query.

5. The method of claim 4, further comprising:
transmitting the natural language query and the intent classification to a display device of an agent.

6. The method of claim 4, further comprising:
transmitting the input vector and the intent classification to a topic classifier comprising a topic classification machine learning model; and
classifying, by the topic classifier and using the input vector, a topic of the natural language query.

7. The method of claim 6, further comprising:
generating, automatically and based on the intent classification and the topic, a chatbot response to the natural language query; and
transmitting the chatbot response to a user device.

8. The method of claim 4, further comprising:
transmitting the input vector to a topic classifier comprising a topic classification machine learning model;
classifying, by the topic classification machine learning model, a topic of the natural language query;
selecting, from among a plurality of chatbots and based on the topic, a selected chatbot;
generating, automatically by the selected chatbot and based on the intent classification of the natural language query, a chatbot response to the natural language query; and
transmitting the chatbot response to a user device.

9. The method of claim 4, further comprising:
generating a weighted classification by applying a weight to the intent classification;
generating a comparison by comparing the weighted classification to a threshold; and
routing the intent classification based on the comparison.

10. The method of claim 9, wherein routing comprises, responsive to the comparison failing to satisfy the threshold, transmitting the natural language query and the intent classification to a display device of an agent.

11. The method of claim 9, wherein routing comprises, responsive to the comparison satisfying the threshold, transmitting the input vector and the intent classification to a topic classifier comprising a topic classification machine learning model, and wherein the method further comprises:
generating, automatically using the topic classifier, a chatbot response to the natural language query; and
transmitting the chatbot response to a user device.

12. The method of claim 9, wherein routing comprises, responsive to the comparison satisfying the threshold, transmitting the input vector and the intent classification to a topic classifier comprising a topic classification machine learning model, and wherein the method further comprises:
classifying, by the topic classifier, a topic of the natural language query;
selecting, from among a plurality of chatbots and based on the topic, a selected chatbot;
generating, automatically by the selected chatbot and based on the intent classification of the natural language query, a chatbot response to the natural language query; and
transmitting the chatbot response to a user device.

13. The method of claim 1, further comprising:
inputting, responsive to the output label comprising deep, the input vector to a deep classifier comprising deep natural language machine learning model;
outputting, by the deep classifier, an intent classification that represents an intent of the natural language query;
generating a weighted classification by applying a weight to the intent classification;
generating a comparison by comparing the weighted classification to a threshold;
transmitting, responsive to the comparison satisfying the threshold, the input vector and the intent classification to a topic classifier comprising a topic classification machine learning model;
classifying, by the topic classifier, a topic of the natural language query;
selecting, from among a plurality of chatbots and based on the topic, a selected chatbot;
generating, automatically by the selected chatbot and based on the intent classification of the natural language query, a chatbot response to the natural language query; and
transmitting the chatbot response to a user device.

14. A system comprising:
a processor;
a data repository in communication with the processor and storing:
a natural language query,
an input vector,
an output label comprising one of a shallow machine learning classification problem and a deep machine learning classification problem;
a shallow-deep classifier executable by the processor, wherein the shallow-deep classifier comprises a classifier machine learning model programmed to determine whether the natural language query represents the shallow machine learning classification problem or the deep machine learning classification problem; and
a server controller which, when executed by the processor, is programmed to:
receive the natural language query,
generate the input vector by performing vectorization on the natural language query, and
generate the output label by executing the shallow-deep classifier on the input vector.

15. The system of claim 14, further comprising:
a deep classifier executable by the processor, wherein the deep classifier is trained to take, as input, the input vector and to generate, as output, an intent classification of the natural language query,
wherein the server controller is further programmed to execute the deep classifier to generate the intent classification.

16. The system of claim 15, wherein the intent classification comprises the deep machine learning classification problem, and wherein the server controller is further programmed to:
generate a weighted classification by applying a weight to the intent classification;
generate a comparison by comparing the weighted classification to a threshold; and
route the intent classification based on the comparison.

17. The system of claim 16, wherein the server controller is further programmed to perform one of:
routing the intent classification and the natural language query to a display device of an agent; or
route the intent classification and the input vector to a topic classifier.

18. The system of claim 14, further comprising:
a topic classifier executable by the processor, wherein the topic classifier is trained to take, as input, the input vector and to generate, as output, a topic of the natural language query; and
a selected chatbot selected from among a plurality of chatbots, wherein the plurality of chatbots comprise natural language processing machine learning models;
wherein the server controller is further programmed to:
generate the topic by executing the topic classifier on the input vector, select, based on the topic, the selected chatbot,
generate, by executing the selected chatbot on the input vector, a chatbot response, and
returning the chatbot response.

19. The system of claim 14, further comprising:
a vector generator executable by the processor, wherein the vector generator is programmed to transform the natural language query to the input vector,
wherein the server controller is further programmed to generate, using the vector generator, the input vector.

20. A method comprising:
receiving a natural language query from a user interface of a chatbot;
generating an input vector by performing vectorization on the natural language query;
inputting the input vector to a shallow-deep classifier, wherein the shallow-deep learning classifier comprises a classification machine learning model programmed to classify the input vector as being one of a shallow machine learning classification problem and a deep machine learning classification problem;
outputting, by the shallow-deep classifier, an output label, wherein the output label comprises one of the shallow machine learning classification problem and the deep machine learning classification problem;
inputting, responsive to the output label comprising deep, the input vector to a deep classifier comprising deep natural language machine learning model;
outputting, by the deep classifier, an intent classification that represents an intent of the natural language query;
generating a weighted classification by applying a weight to the intent classification;
generating a comparison by comparing the weighted classification to a threshold;
transmitting either i) the input vector and the intent classification to a topic classifier comprising a topic classification machine learning model when the comparison satisfies the threshold, or, ii) the input vector to the topic classifier when the output label comprises the shallow machine learning classification problem;
classifying, by the topic classifier executing on the input vector, a topic of the natural language query;
selecting, from among a plurality of chatbots and based on the topic, a selected chatbot;
generating, automatically by the selected chatbot, a chatbot response to the natural language query, wherein the selected chatbot also uses the intent classification to generate the chatbot response when the intent classification is present; and
transmitting the chatbot response to a user device.
